(19) United States
(12) Patent Application Publication
(10) Pub. No.: US 2022/0162115 A1
(43) Pub. Date: May 26, 2022

(54) CHEMICALLY STRENGTHENED OPTICAL GLASS

(71) Applicants: SCHOTT Glass Technologies (Suzhou) Co. Ltd., Suzhou New District (CN); SCHOTT AG, Mainz (DE)

(72) Inventors: Yigang Li, Shanghai (CN); Haiyi Bian, Jiangsu (CN); Simone Monika Ritter, Mainz (DE); Hongyun Wang, Jiangsu (CN)

(73) Assignees: SCHOTT Glass Technologies (Suzhou) Co. Ltd., Suzhou New District (CN); SCHOTT AG, Mainz (DE)

(21) Appl. No.: 17/531,886

(22) Filed: Nov. 22, 2021

(30) Foreign Application Priority Data
Nov. 23, 2020 (CN) 202011321471.4

(51) Int. Cl. C03C 4/18; C03C 3/097; C03C 3/064; C03C 21/00

(52) U.S. Cl. CPC C03C 4/18; C03C 3/097; C03C 2204/00; C03C 21/002; C03C 3/064

(57) ABSTRACT

The present invention relates to a chemically strengthened optical component comprising an optical glass, having a depth of layer (DoL) of 1.0 to 50.0 μm, wherein the optical glass has a refractive index n_{d} of at least 1.65, preferably at least 1.70, and wherein the optically glass comprises at least 5 mol % of a total of Li₂O, Na₂O and K₂O or a combination of two or more thereof. The invention furthermore relates to a method for preparing the chemically strengthened optical component and the use thereof.

The present invention relates to a chemically strengthened optical component comprising an optical glass, having a depth of layer (DoL) of 1.0 to 50.0 μm, wherein the optical glass has a refractive index n_{d} of at least 1.65, preferably at least 1.70, and wherein the optically glass comprises at least 5 mol % of a total of Li₂O, Na₂O and K₂O or a combination of two or more thereof. The invention furthermore relates to a method for preparing the chemically strengthened optical component and the use thereof.

### TECHNICAL BACKGROUND

Chemical toughening is a well-known process to increase the mechanical strength of soda lime glass or aluminosilicate glass or lithium aluminosilicate or borosilicate glass, e.g. used as cover glass for display applications.

For chemical toughening a glass article is placed in a special bath of at least one molten salt having a predetermined temperature for a defined time. During toughening, an ion exchange takes place at the surface of the glass article wherein smaller cations (especially monovalent cations) are replaced by cations having a larger radius. After the toughening process, the glass article is lifted out of the salt bath, subsequently cooled and cleaned.

The above-described process is well known for glasses having a relatively high silicate content and a relatively low refractive index, e.g. of not more than 1.65.

US 2004/0220038 A1 and US 2004/0229743 A1 discloses short optical aluminosilicate glasses suitable for ion exchange processes having a refractive index n_{d} of not more than 1.65, and an Abbe coefficient of at least 48. The described glasses may be used as core glass in optical fibers.

CN 102633434 A describes silicate glass substrate materials for integrated optics having an improved chemical stability, which may serve as substrate material for the preparation of glass-based ion exchanged optical waveguides.

In U.S. Pat. No. 8,889,254 B2 impact-damage-resistant glass sheets for consumer electronic video display devices are described. For increasing the mechanical strength of said sheets, the surface of alkali aluminosilicate glass sheets is brought into contact with an ion-exchange strengthening medium comprising a source of alkali metal ion components of larger ionic diameter than at least one alkali metal component present in the glass.

WO 2019/242673 A1 describes a chemically toughened alkali aluminosilicate based thin glass having no optical orange skin and a method for the preparation thereof.

However, there is still a need for optical components having a high refractive index and a high mechanical stability. This applies in particular for optical components used in mechanically challenging environments, such as lenses in smartphone cameras, sport cameras, or automotive cameras or waveguides, e.g. for augmented reality applications. Optical components for the described applications moreover are required to have well defined and reproducible optical properties, e.g. a very specific refractive index suitable for the particular application.

None of the above-cited documents provides a high refractive index glass having improved mechanical strength and reproducible optical properties, which are indispensable for the application of optical components in challenging environments.

It was therefore one objective of the present invention to provide a chemically strengthen optical component having improved mechanical strength and predictable and reproducible optical properties.

This objective was solved by a chemically strengthened optical component comprising an optical glass, having a Depth of Layer (DoL) of 1.0 to 50.0 μm, wherein the optical glass has a refractive index n_{d} of at least 1.65, preferably at least 1.70 and wherein the optically glass comprises at least 5 mol % of a total of Li₂O, Na₂O and K₂O or a combination of two or more thereof.

It was surprisingly found that the chemically strengthened optical component according to the invention shows improved mechanical strength and simultaneous a good reproducibility of the refractive index after strengthening. Moreover, it was found that glasses comprising a relatively low amount of SiO₂ and being essentially free of Al₂O₃ can be effectively strengthened by the method according to the invention. It was further found that an effective increase of the mechanical strength could be achieved already by relatively small DoL.

### BRIEF DESCRIPTION OF THE DRAWINGS

FIG. 1 illustrates the DOL in the chemically strengthened optical comptometer E6* after an ion-exchange process.

### DETAILED DESCRIPTION OF THE INVENTION

### Optical Glass

The chemically strengthened optical component comprises an optical glass having a refractive index n_{d} of at least 1.65, preferably at least 1.70 or more, preferably 1.75 or more, and particularly preferably 1.80 or more. Preferably, the refractive index n_{d} of the optical glass is 2.20 or less, preferably 2.10 or less and particularly preferably 2.05 or less. Preferably, the refractive index n_{d} is in the range of 1.70 to 2.20, preferably 1.75 to 2.05, more preferably 1.80 to 2.00 and particularly preferably from 1.80 to 1.98.

“Optical component” for the purpose of the present inventions means a component, which can be of any size, e.g but not limited to lenses, prisms, wafer, aspheric lenses, rod lenses, and freeform glass articles.

Depth of Layer (DoL): The thickness of ion-exchanged layer measured with SEM-EDS to scan the cross section of the ion-exchanged region of the glass. The ratio of K/Na following the depth to surface clearly reveals the thickness of ion-exchanged layer. After the DoL, i.e. in the bulk of the glass, the concertation of exchanged ions correspond to the particular concentrations in the nonstrengthened glass.

The chemically strengthened optical component has a Depth of Layer (DoL) of 1.0 to 50.0 μm. In a preferred embodiment of the invention the DoL is at least 1.5 μm, preferably at least 2.0 μm and particularly preferably at least 4 μm. Preferably the DoL is not more than 40.0 μm, preferably not more than 30.0 μm, more preferably not more than 15.0 μm.

The optical glass has an Abbe number v_{d} of 15 to 35, preferably 20 to 30, particularly preferably 21 to 27.

Preferably, the refractive indices n_{d} of the optical glass and the chemically strengthen optical component at a specific wavelength differ from each other not more than 0.100, preferably not more than 0.010, more preferably not more than 0.005 and particularly preferably not more than 0.002 within the depth range from surface to DoL.

The optical glass comprises at least 5 mol %, more preferably at least 10 mol %, more preferably at least 13 mol % and particularly preferably at least 15 mol % of a total of Li₂O, Na₂O and K₂O or a combination of two or more thereof. Preferably, the optical glass comprises not more than 45 mol %, preferably not more than 40 mol %, more preferably not more than 37 mol % and particularly preferably not more than 25 mol % of a total of Li₂O, Na₂O and K₂O or a combination of two or more thereof.

Alkaline oxides like K₂O, Na₂O and Li₂O work as the glass network modifier. They can break the glass network and form non-bridge oxide inside the glass network. Adding alkaline could reduce the working temperature of glass. The sodium, lithium and potassium content is important for optical glass which is chemical strengthenable, for Li⁺/Na⁺, Na⁺/K⁺, Li⁺/K⁺ and Na⁺/Rb⁺, Na⁺/Cs⁺, K⁺/Rb⁺, K⁺/Cs⁺ ion exchange is a necessary step for the toughening, the glass will not be toughened if it does not contain alkaline itself.

The optical glass of the invention may comprise 0 to 15 mol % LiO₂. Preferably the optical glass comprises not more than 10 mol %, more preferably not more than 5 mol %, more preferably not more than 3 mol %. Some preferred embodiments are free of Li₂O.

The optical glass of the invention preferably comprises 0 to 35 mol % Na₂O. Preferably the optical glass comprises at least 3 mol %, preferably at least 5 mol %, more preferably at least 10 mol % Na₂O. The optical glass comprises preferably not more than 35 mol % preferably not more than 30 mol % and particularly preferably not more than 25 mol % Na₂O. Sodium is very important for the chemical toughening performance as the chemical toughening preferably comprises the ion exchange of sodium in the glass with potassium in the chemical toughening medium. However, the content of sodium should also not be too high because the glass network may be severely deteriorated, the n_{d} will decrease too strong and glass may be extremely hard to be formed.

The optical glasses of the invention may comprise K₂O. However, as the glasses are preferably chemically toughened by exchanging sodium ions in the glass with potassium ions in the chemical toughening medium, a too high amount of K₂O in the glass will compromise the chemical toughening performance.

The optical glass of the invention preferably comprises 0 to 15 mol % K₂O. Preferably, the optical glass comprises at least 3 mol %, more preferably at least 5 mol % of K₂O. The optical glass preferably comprises not more than 10 mol %, preferably not more than 7 mol % and particularly not more than 5 mol % K₂O. Some preferred embodiments are even free of K₂O.

In one preferred embodiment of the invention the optical glass comprises one alkali oxide selected from Li₂O, Na₂O and K₂O, wherein the alkali oxide is preferably Na₂O or Li₂O, and more preferably Na₂O. Preferably, the optical glass comprises at least 8 mol %, preferably at least 10 mol % Na₂O and optionally at least one of Li₂O and K₂O. In another preferred embodiment the optical glass comprises at least 10 mol % Na₂O, at least 3 mol % K₂O and optionally Li₂O.

In another preferred embodiment of the invention, the optical glass comprises more than one alkali oxide, preferably Na₂O and one of Li₂O and K₂O, preferably Na₂O and K₂O and optionally Li₂O and particularly preferably Na₂O and K₂O. Preferably the optical glass comprises Na₂O and K₂O wherein the molar ratio of Na₂O to K₂O (Na₂O/K₂O) is more than 1.0, preferably more than 1.5, particularly more than 2.0 and preferably less than 7.0, preferably less than 6.5 and particularly less than preferably more than 5.0.

The optical glass of the invention preferably comprises at least one of SiO₂ and P₂O₅ as major glass network former. Additionally, also B₂O₃ may be used as additional glass network formers.

The optical glass of the invention may comprise 0.5 to 65 mol % SiO₂. A high SiO₂ content will require high melting and working temperature of glass production, a high SiO₂ content also will limit the refractive index of the glass to be not more than 1.65, therefore the SiO₂ content should be limited. Preferably, the optical glass of the invention may comprise SiO₂ in an amount of not more than 50 mol %, more preferably not more than 47 mol %, more preferably not more than 45 mol %, and particularly preferably not more than 42 mol % SiO₂.

The optical glass of the invention may comprise P₂O₅ in amount of not more than 35 mol %, preferably not more than 30 mol %, and particularly preferably not more than 25 mol %.

The content of the sum of SiO₂ and P₂O₅ preferably is not more than 65 mol %, more preferably not more than 50 mol %, preferably not more than 47 mol % and particularly preferably not more than 42 mol %, and preferably at least 15 mol %, and particularly preferably at least 18 mol %.

B₂O₃ in the glass network forms two different polyhedron structures or 6-membered rings, which are more adaptable to loading force from outside. Addition of B₂O₃ can usually result in lower thermal expansion and lower Young's modulus which in turn leads to good thermal shock resistance and slower chemical toughening speed through which low DoL could be easily obtained. Therefore, the addition of B₂O₃ to the optical glass could greatly improve the chemical toughening processing window of the optical glass and widen the practical application of chemically toughened optical component. However, the chemical toughening performance is reduced when the amount of B₂O₃ is too high.

In preferred embodiments, the amount of B₂O₃ in the glass of the invention is not more than 15 mol %, more preferably not more than 12 mol % and particularly preferably not more than 10 mol %. Preferably, the optical glass comprises at least 1 mol %, preferably at least 3 mol % B₂O₃. Moreover, the chemical toughening performance is reduced when the amount of B₂O₃ is too high.

Al₂O₃ works both as glass network former and glass network modifier. The [AlO₄] tetrahedral and [AlO₆] hexahedral will be formed in the glass network depending on the amount of Al₂O₃. Therefore, the optical glass of the invention may comprise Al₂O₃. However, in high refractive glasses Al₂O₃ may increase the tendency of crystallization. Therefore, the amount of Al₂O₃ in the optical glasses according to the invention is preferably is limited to an amount of not more than 2 mol %, preferably not more than 1.5 mol %, more preferably not more than 1 mol %. Particularly preferred embodiments are free of Al₂O₃.

Alkaline earth oxides such as MgO, CaO, SrO, BaO work as the network modifier and decrease forming temperature of glass. These oxides can be added to adjust the CTE and Young's modulus of glass. Alkaline earth oxides have very important function that they can change refractive index of glass to meet special requirements. For example, depending on the other components of the glass matrix, MgO could decrease the refractive index of glass and BaO could increase the refractive index. Moreover, the crystallization tendency may be increased if the amount of alkaline earth oxides is too high. Some advantageous variants can be free of alkaline earth oxides.

The optical glass of the invention may comprise MgO in an amount of not more than 10 mol %, preferably not more than 4 mol % and particularly preferably not more than 3 mol %. Preferred embodiments of the optical glass are MgO-free.

The optical glass of the invention may comprise CaO in an amount of not more than 10 mol %, preferably not more than 7 mol %, preferably not more than 5 mol % and particularly preferably not more than 3 mol %. Some preferred embodiments of the optical glass are CaO-free.

The optical glass of the invention may comprise SrO in an amount of not more than 10 mol %, preferably not more than 5 mol %, more preferably not more than 3 mol % and particularly preferably not more than 1 mol %. Some preferred embodiments of the optical glass are SrO-free.

The optical glass of the invention may comprise BaO in an amount of not more than 15 mol %, preferably not more than 12 mol % and particularly preferably not more than 10 mol %. In some embodiments, the optical glass of the invention may comprise BaO in an amount of at least 1 mol %, preferably at least 2 mol % and particularly preferably at least 3 mol %. Some preferred embodiments of the optical glass are BaO-free.

In some preferred embodiments of the optical glass of the invention, the sum of MgO, CaO, SrO and BaO is not more than 20 mol %, preferably not more than 16 mol % and particularly preferably not more than 14 mol %.

The optical glass of the invention may comprise ZnO in an amount of not more than 10 mol %, preferably not more than 5 mol % and particularly preferably not more than 3 mol %, however, preferred embodiments are ZnO-free.

Preferably, the optical glass of the invention comprise TiO₂ in an amount of not more than 35 mol %, preferably not more than 32 mol % and particularly preferably not more than 30 mol %, an preferably at least 3 mol %, preferably at least 7 mol % and particularly preferably at least 15 mol %.

Preferably, the optical glass of the invention comprises Nb₂O₅ in an amount of not more than 35 mol %, preferably not more than 32 mol % and particularly preferably not more than 30 mol %, and preferably at least 3 mol %, preferably at least 7 mol % and particularly preferably at least 15 mol %. Some preferred embodiments are Nb₂O₅-free.

Preferably, the sum of TiO₂ and Nb₂O₅ (Σ (TiO₂, Nb₂O₅)) is not more than 55 mol %, preferably not more than 45 mol % and particularly preferably not more than 40 mol %, and preferably at least 18 mol %, preferably at least 20 mol %, and preferably at least 22 mol %.

The optical glass of the invention may comprise up to 30 mol % of one or more Ln₂O₃ (Ln=La, Y, Gd), preferably up to 25 mol %, and particularly preferably up to 20 mol %, however, preferred embodiments are Ln₂O₃-free.

The optical glass of the invention may comprise up to 9 mol %, preferably up to 7 mol % and particularly preferably up to 5 mol % ZrO₂, however, preferred embodiments are ZrO₂-free.

The optical glass may comprise up to 10 mol %, preferably up to 5 mol % and preferably 3 mol % Ta₂O₅, however, preferred embodiments are Ta₂O₅-free.

As₂O₃, Sb₂O₃, SnO₂, SO₃, Cl and/or F could be also added as refining agents in an amount of from 0 to 2 wt. %. Preferably, the optical glass of the invention may comprise up to 0.5 mol %, preferably up to 0.3 mol % of one or more of Sb₂O₃, SnO₂, As₂O₃, SO₃, Cl, and/or F.

Rare earth metal oxides such as Yb₂O₃, CeO₂, Nd₂O₃, Lu₂O₃ or Gd₂O₃ could also be comprised in an amount of 0 to 5 mol % to add magnetic or photonic or optical functions to the optical glass. Preferably, the optical glass of the invention is free of those components.

Some transition metal oxides may be comprised in the optical glass of the invention, such as Fe₂O₃, CoO, NiO, V₂O₅, MnO₂, CuO, and Cr₂O₃, or a mixture of two or more thereof, which work as coloring agents to make glass with specific optical or photonic functions, for example, color filter or light convertor. In one embodiment of the invention, the optical glass has a composition in mol % comprising, preferably consisting of:

| Component | mol % |
|---|---|
| SiO₂ | 0-50 |
| Al₂O₃ | 0-2 |
| B₂O₃ | 0-15 |
| P₂O₅ | 0-35 |
| Li₂O | 0-15 |
| Na₂O | 0-35 |
| K₂O | 0-15 |
| Σ R₂O (R = Li, Na, K) | 5-45 |
| MgO | 0-10 |
| CaO | 0-10 |
| SrO | 0-10 |
| BaO | 0-15 |
| R′O (R′ = Mg, Ca, Sr, Ba) | 0-20 |
| ZnO | 0-10 |
| TiO₂ | 3-35 |
| Nb₂O₅ | 3-35 |
| Σ (TiO₂ + Nb₂O₅) | 20-55 |
| Ln₂O₃ (Ln = La, Y, Gd) | 0-10 |
| ZrO₂ | 0-5 |
| Σ (Sb₂O₃, As₂O₃, SnO₂, Cl, F, | 0-0.5 |
| SO₃) | |

In one preferred embodiment of the invention, the optical glass is a SiO₂-based glass comprising at least 25 mol % SiO₂.

Accordingly, a chemically strengthened optical component is provided comprising an optical glass having a composition in mol % comprising, preferably consisting of:

| Component | mol % |
|---|---|
| SiO₂ | 25-50 |
| Al₂O₃ | 0-2 |
| B₂O₃ | 0-10 |
| P₂O₅ | 0-5 |
| Li₂O | 0-15 |
| Na₂O | 0-30 |
| K₂O | 0-10 |
| Σ R₂O (R = Li, Na, K) | 5-25 |
| MgO | 0-5 |
| CaO | 0-5 |
| SrO | 0-3 |
| BaO | 0-15 |
| Σ R′O (R′ = Mg, Ca, Sr, Ba) | 5-15 |
| ZnO | 0-5 |
| TiO₂ | 20-35 |
| Nb₂O₅ | 1-15 |
| Σ (TiO₂ + Nb₂O₅) | 22-45 |
| Ln₂O₃ (Ln = La, Y, Gd) | 0-5 |
| ZrO₂ | 0-5 |
| Σ (Sb₂O₃, As₂O₃, SnO₂, Cl, F, | 0-0.5 |
| SO₃) | |

The amount of SiO₂ in the optical glass is 25 to 50 mol %, preferably 30 to 47 mol % and particularly preferably 32 to 45 mol %.

The amount of Al₂O₃ in the SiO₂-based glass is 0 to 2 mol %, preferably 0 to 1 mol % and particularly preferably 0 to 0.5 mol %. Some preferred embodiments of the SiO₂-based glass are Al₂O₃-free.

The amount of B₂O₃ in the SiO₂-based glass is 0 to 10 mol %, preferably 0 to 5 mol % and particularly preferably 0 to 3 mol %. Some preferred embodiments of the SiO₂-based glass are B₂O₃-free.

The amount of P₂O₅ in the SiO₂-based glass is 0 to 5 mol %, preferably 0 to 2 mol % and particularly preferably 0.1 to 4 mol %, and particularly preferably 0.5 to 3. Some preferred embodiments of the SiO₂-based glass are P₂O₅-free.

The total amount of alkali oxides R₂O, wherein R is Li, Na, and/or K in the SiO₂ based glass is 5 to 25 mol %, preferably 10 to 22 mol % and particularly preferably 13 to 20 mol %.

The amount of Li₂O in the SiO₂-based glass is 0 to 15 mol %, preferably 0 to 10 mol % and particularly preferably 0 to 5 mol %. Preferred embodiments of the SiO₂-based glass are Li₂O-free.

The amount of Na₂O in the SiO₂-based glass is 0 to 30 mol %, preferably 5 to 25 mol % and particularly preferably 10 to 20 mol %.

The amount of K₂O in the SiO₂-based glass is 0 to 10 mol %, preferably 2 to 7 mol % and particularly preferably 4 to 6 mol %. Some preferred embodiments of the SiO₂-based glass are K₂O-free.

The total amount of earth alkali oxides R′O, wherein R′ is Mg, Ca, Sr, and/or Ba in the SiO₂-based glass is 3 to 18 mol %, preferably 56 to 13 mol % and particularly preferably 6 to 12 mol %.

The amount of MgO in the SiO₂-based glass is 0 to 5 mol %, preferably 0 to 4 mol % and particularly preferably 0.5 to 3 mol %. Some preferred embodiments of the SiO₂-based glass are MgO-free.

The amount of CaO in the SiO₂-based glass is 0 to 10 mol %, preferably 0.5 to 8 mol % and particularly preferably 1.0 to 7 mol %. Some preferred embodiments of the optical glass are CaO-free.

The amount of SrO in the SiO₂-based glass is 0 to 3 mol %, preferably 0 to 1 mol % and particularly preferably 0 to 0.5 mol %. Some preferred embodiments of the SiO₂-based glass are SrO-free.

The amount of BaO in the SiO₂-based glass is 0 to 15 mol %, preferably 3 to 12 mol % and particularly preferably 5 to 10 mol %. Some preferred embodiments of the SiO₂-based glass are BaO-free.

The SiO₂-based glass may comprise less than 10 mol % ZnO, preferably less than 5 mol % however, preferred embodiments are ZnO-free.

The amount of TiO₂ in the SiO₂-based glass is 20 to 35 mol %, preferably 22 to 34 mol % and particularly preferably 25 to 34 mol %.

The amount of Nb₂O₅ in the SiO₂-based glass is 1 to 15 mol %, preferably 2 to 12 mol % and particularly preferably 4 to 11 mol %.

The sum of TiO₂ and Nb₂O₅ (Σ (TiO₂, Nb₂O₅)) in the SiO₂-based glass is 22 to 45 mol %, preferably 25-42 mol %, particularly preferably 30 to 38 mol %.

The SiO₂-based glass of the invention may comprise up to 5 mol % of one or more Ln₂O₃ (Ln=La, Y, Gd), preferably up to 3 mol %, however, preferred embodiments are Ln₂O₃-free.

The SiO₂-based glass may comprise up to 5 mol %, preferably up to 3 mol % and particularly preferably up to 2 mol % ZrO₂, however, preferred embodiments are ZrO₂-free.

The SiO₂-based glass of the invention may comprise up to 0.5 mol %, preferably up to 0.3 mol % of one or more of Sb₂O₃, SnO₂, As₂O₃, Cl, F and SO₃.

Preferably, the SiO₂-based glass comprises at least 8 mol %, preferably at least 10 mol % Na₂O and optionally at least one of Li₂O and K₂O, preferably K₂O Also preferably, the SiO₂-based glass comprises at least 10 mol % Na₂O, at least 1.5 mol % K₂O and optionally Li₂O. In a preferred embodiment of the invention, the SiO₂-based glass is Li₂O-free.

In one preferred embodiment the chemically strengthened optical component comprises a SiO₂-based glass, wherein the optical glass comprises Na₂O, K₂O and optionally Li₂O, wherein the molar ratio of Na₂O to K₂O (Na₂O/K₂O) is more than 1.5, preferably more than 2.0, preferably more than 2.5, and less than 7.0, preferably less than 5.0, preferably less than 4.0 and preferably less than 3.5. In a preferred embodiment, the SiO₂-based glass is Li₂O-free.

In one preferred embodiment of the invention the optical glass having a composition in mol % comprising, preferably consisting of:

| Component | mol % |
|---|---|
| SiO₂ | 35-45 |
| Al₂O₃ | 0-5.0 |
| B₂O₃ | 0-3 |
| P₂O₅ | 0-0.5 |
| Li₂O | 0-0.5 |
| Na₂O | 10-20 |
| K₂O | 0-6 |
| Σ R₂O (R = Li, Na, K) | 15-20 |
| MgO | 0-2 |
| CaO | 0.5-3.5 |
| SrO | 0-0.1 |
| BaO | 5-10 |
| Σ R′O (R′ = Mg, Ca, Sr, Ba) | 8-12 |
| ZnO | 0-0.5 |
| TiO₂ | 26-33 |
| Nb₂O₅ | 3-7 |
| Σ (TiO₂ + Nb₂O₅) | 29-36 |
| Ln₂O₃ (Ln = La, Y, Gd) | 0-0.5 |
| ZrO₂ | 0-2 |
| Σ (Sb₂O₃, As₂O₃, SnO₂, Cl, F, | 0-0.1 |
| SO₃) | |
| Molar ratio Na₂O/K₂O | 2.0-3.5 |

In another preferred embodiment of the invention, the optical glass having a composition in mol % comprising, preferably consisting of:

| Component | mol % |
|---|---|
| SiO₂ | 28-35 |
| Al₂O₃ | 0-0.50 |
| B₂O₃ | 0-1 |
| P₂O₅ | 0-0.5 |
| Li₂O | 0-0.5 |
| Na₂O | 10-15 |
| K₂O | 1-5 |
| Σ R₂O (R = Li, Na, K) | 12-16 |
| MgO | 0-1 |
| CaO | 5-8 |
| SrO | 0-0.1 |
| BaO | 5-10 |
| Σ R′O (R′ = Mg, Ca, Sr, Ba) | 10-18 |
| ZnO | 0-0.5 |
| TiO₂ | 26-33 |
| Nb₂O₅ | 7-12 |
| Σ (TiO₂ + Nb₂O₅) | 35-45 |
| Ln₂O₃ (Ln = La, Y, Gd) | 0-0.5 |
| ZrO₂ | 0-1 |
| Σ (Sb₂O₃, SnO₂, As₂O₃, Cl, F, | 0-0.1 |
| SO₃) | |
| Molar ratio Na₂O/K₂O | 5.0-7.0 |

In a further preferred embodiment of the invention, the optical glass is a P₂O₅ based glass comprising at least 15 mol % P₂O₅.

Accordingly, a chemically strengthened optical component is provided comprising an optical glass having a composition in mol % comprising, preferably consisting of:

| Component | mol % |
|---|---|
| SiO₂ | 0-5 |
| Al₂O₃ | 0-2 |
| B₂O₃ | 0-15 |
| P₂O₅ | 15-35 |
| Li₂O | 0-15 |
| Na₂O | 5-35 |
| K₂O | 0-10 |
| Σ R₂O (R = Li, Na, K) | 10-45 |
| MgO | 0-5 |
| CaO | 0-10 |
| SrO | 0-5 |
| BaO | 0-15 |
| Σ R′O (R′ = Mg, Ca, Sr, Ba) | 0-15 |
| ZnO | 0-5 |
| TiO₂ | 3-35 |
| Nb₂O₅ | 10-35 |
| Σ (TiO₂ + Nb₂O₅) | 20-55 |
| Ln₂O₃ (Ln = La, Yb, Gd) | 0-10 |
| ZrO₂ | 0-5 |
| Σ (Sb₂O₃, As₂O₃, SnO₂, Cl, F, | 0-0.5 |
| SO₃) | |

The amount of SiO₂ in the P₂O₅-based glass is 0 to 5 mol %, preferably 0.5 to 3 mol % and particularly preferably 1 to 2 mol %. Some preferred embodiments of the P₂O₅-based glass are SiO₂-free.

The amount of Al₂O₃ in the P₂O₅-based glass is 0 to 2 mol %, preferably 0 to 1 mol % and particularly preferably 0 to 0.5 mol %. Some preferred embodiments of the P₂O₅-based glass are Al₂O₃-free.

The amount of B₂O₃ in the P₂O₅-based glass is 0 to 15 mol %, preferably 1 to 12 mol % and particularly preferably 3 to 10 mol %. Some preferred embodiments of the P₂O₅-based glass are B₂O₃-free.

The amount of P₂O₅ in the P₂O₅-based glass is 15 to 35 mol %, preferably 17 to 30 mol % and particularly preferably 18 to 25 mol %.

The amount of alkali oxides (R₂O wherein R is Li, Na, K) in the P₂O₅-based glass is 10 to 45 mol %, preferably 15 to 40 mol % and particularly preferably 25 to 38 mol %.

The amount of U₂O in the P₂O₅-based glass is 0 to 15 mol %, preferably 0 to 5 mol % and particularly preferably 0 to 3 mol %. Preferred embodiments of the P₂O₅-based glass are U₂O-free.

The amount of Na₂O in the P₂O₅-based glass is 5 to 35 mol %, preferably 15 to 33 mol % and particularly preferably 20 to 32 mol %.

The amount of K₂O in the P₂O₅-based glass is 0 to 10 mol %, preferably 3 to 10 mol % and particularly preferably 5 to 8 mol %. Some preferred embodiments of the P₂O₅-based glass are K₂O-free.

In P₂O₅-based optical glasses obtaining Na₂O and K₂O the molar ratio of Na₂O/K₂O preferably is from 3.0 to 5.0, more preferably from 3.5 to 4.5 and particularly preferably from 4.0 to 4.4.

The amount of earth alkali oxides (R′O wherein R′ is Mg, Ca, Sr, Ba) in the P₂O₅ based glass is 0 to 15 mol %, preferably 0 to 7 mol % and particularly preferably 0 to 3 mol %. Some preferred embodiments of the P₂O₅-based glass are R′O-free.

The amount of MgO in the optical glass is 0 to 5 mol %, preferably 0 to 4 mol % and particularly preferably 0.5 to 3 mol %. Preferred embodiments of the P₂O₅ based glass are MgO-free.

The amount of CaO in the P₂O₅-based glass is 0 to 10 mol %, preferably 0 to 6 mol % and particularly preferably 0 to 1 mol %. Some preferred embodiments of the P₂O₅-based glass are CaO-free.

The amount of SrO in the P₂O₅-based glass is 0 to 5 mol %, preferably 0 to 3 mol % and particularly preferably 0 to 1 mol %. Some preferred embodiments of the P₂O₅-based glass are SrO-free.

The amount of BaO in the P₂O₅-based glass is 0 to 15 mol %, preferably 0 to 5 mol % and particularly preferably 0 to 3 mol %. Some preferred embodiments of the P₂O₅-based glass are BaO-free.

The P₂O₅-based optical glass may comprise up to 5 mol % ZnO, preferably up to 4 mol %, however, preferred embodiments are ZnO-free.

The amount of TiO₂ in the P₂O₅-based glass is 3 to 35 mol %, preferably 5 to 20 mol % and particularly preferably 10 to 15 mol %.

The amount of Nb₂O₅ in the P₂O₅-based glass is 10 to 35 mol %, preferably 15 to 30 mol % and particularly preferably 20 to 30 mol %.

The sum of TiO₂ and Nb₂O₅ (Σ (TiO₂, Nb₂O₅)) in the P₂O₅-based glass is 20 to 55 mol %, preferably 25-45 mol %, particularly preferably 30 to 36 mol %.

The P₂O₅-based glass of the invention may comprise up to 10 mol % of one or more Ln₂O₃ (Ln=La, Y, Gd), preferably up to 3 mol %, however, preferred embodiments are Ln₂O₃-free.

The P₂O₅-based glass may comprise up to 5 mol %, preferably up to 3 mol % ZrO₂, however, preferred embodiments are ZrO₂-free.

The P₂O₅-based glass of the invention may comprise up to 0.5 mol %, preferably up to 0.3 mol % of one or more of Sb₂O₃, SnO₂, As₂O₃.

In a preferred embodiment, the P₂O₅-based glass optical glass has a composition in mol % comprising, preferably consisting of:

| Component | mol % |
|---|---|
| SiO₂ | 0-3 |
| Al₂O₃ | 0-0.5 |
| B₂O₃ | 0-10 |
| P₂O₅ | 18-28 |
| Li₂O | 0-0.5 |
| Na₂O | 18-32 |
| K₂O | 0-8, |
| | preferably 0 |
| Σ R₂O (R = Li, Na, K) | 18-40 |
| MgO | 0-0.5 |
| CaO | 0-7 |
| SrO | 0-0.2 |
| BaO | 0-10 |
| Σ R′O (R′ = Mg, Ca, Sr, Ba) | 0-15 |
| ZnO | 0-5 |
| TiO₂ | 3-15 |
| Nb₂O₅ | 18-28 |
| Σ (TiO₂ + Nb₂O₅) | 28-35 |
| Ln₂O₃ (Ln = La, Yb, Gd) | 0-0.5 |
| ZrO₂ | 0-0.5 |
| Σ (Sb₂O₃, As₂O₃, SnO₂, Cl, F, | 0-0.5 |
| SO₃) | |

In another preferred embodiment, the P₂O₅-based optical glass has a composition in mol % comprising, preferably consisting of:

| Component | mol % |
|---|---|
| SiO₂ | 0-1.5 |
| B₂O₃ | 7-10 |
| P₂O₅ | 18-22 |
| Li₂O | 0-0.5 |
| Na₂O | 27-32 |
| K₂O | 5-8 |
| Σ R₂O (R = Li, Na, K) | 34-40 |
| MgO | 0-0.5 |
| CaO | 0-0.5 |
| SrO | 0-0.2 |
| BaO | 0-0.2 |
| Σ R′O (R′ = Mg, Ca, Sr, Ba) | 0-1 |
| ZnO | 0-0.5 |
| TiO₂ | 10-15 |
| Nb₂O₅ | 20-25 |
| Σ (TiO₂ + Nb₂O₅) | 30-35 |
| Ln₂O₃ (Ln = La, Yb, Gd) | 0-0.5 |
| ZrO₂ | 0-0.5 |
| Σ (Sb₂O₃, As₂O₃, SnO₂, Cl, F, | 0-0.5 |
| SO₃) | |
| Molar ratio Na₂O/K₂O | 4.00-4.50 |

### Method for Chemically Strengthening

A further object of the invention was to provide a method for preparing the chemically strengthened optical component comprising the optical glass as specified before.

Generally, strengthening, as called as toughening, can be done by immersing an optical component into a molten salt bath with potassium ions or cover the glass by potassium ions or other alkaline metal ions contained paste and heated at high temperature at certain time. The alkaline metal ions with larger ion radius in the salt bath or the paste exchange with alkaline metal ions with smaller radius in the optical component, and surface compressive stress (CS) is formed due to ion exchange. As described above, immersing the optical component into a bath of molten alkali metal salt is applied here. After lifting the strengthened optical component out of the salt bath and further advantageous steps the optical component is cooled and cleaned using known procedures.

Accordingly, a method for preparing the chemically strengthened optical component is provided, comprising the following steps:
a) providing an optical component comprising an optical glass as described above;
b) immersing the optical component into a bath of molten alkali metal salt at a certain strengthening temperature T1 for a certain strengthening time t1 to prepare a strengthened optical component;
c) lifting the strengthened optical component out of the molten alkali metal salt;
d) cooling and optionally cleaning the strengthened optical component.

As described above the chemically strengthened optical component of the invention is obtained by chemically strengthening an optical component. The strengthening process is done by immersing the optical component into a salt bath containing alkali metal ions to exchange with alkali ions inside the optical component glass. The alkali metal ions in the salt bath has radius larger than alkali ions inside the optical component. A compressive stress to the glass is built up after ion-exchange due to larger ions squeezing in the glass network. After the ion-exchange, the mechanical strength of the glass is surprisingly and significantly improved. It can be concluded from the improvement of mechanical strength that the CS was successfully induced by chemical strengthening processes, which improves the bending properties of the strengthened optical component and impact resistance of the optical component. Another way to measure the DoL but no CS is to use SEM-EDS to scan the cross section of the ion-exchanged glass. The molar ratio of K₂O/Na₂O following the depth to surface clearly reveals the thickness of ion-exchanged layer.

In step a) of the method according to the invention, an optical component as defined before is provided, wherein the preferred embodiments as described above apply accordingly in connection with the method according to the invention.

According to the invention, the optical component is immersed into a bath of molten alkali metal salt at a certain strengthening temperature for a certain strengthening time.

Preferred molten alkali metal salts comprise at least one of Na⁺, K⁺, Rb⁺ and Cs⁺. Of course, the molten alkali metal salt bath may comprise a mixture of two or more different alkali metal ions, e.g. two, three or four different alkali metal ions. In one preferred embodiment to the method of the invention, the molten alkali metal salt bath comprises one alkali metal salt, preferably Na⁺ or K⁺, particularly preferably K. In another preferred embodiment, the molten alkali metal salt bath comprises a mixture of two different alkali metal ions, preferably a mixture of Na⁺ and K.

Suitable alkali metal salts for the use in a molten alkali metal salt bath according to the invention include, but are not limited to, NaNO₃, KNO₃, NaCl, KCl, K₂SO₄, Na₂SO₄, Na₂CO₃, and K₂CO₃. Accordingly, in a preferred embodiment the molten alkali metal salt bath comprises at least one of NaNO₃, KNO₃, NaCl, KCl, K₂SO₄, Na₂SO₄, Na₂CO₃, and K₂CO₃, preferably at least one of NaNO₃ and KNO₃. Additives like NaOH, KOH and other sodium salt or potassium salt could be also used for better controlling the speed of ion-exchange, and DoL during chemical strengthening. Preferably, the molten alkali metal salt bath comprises at least one alkali metal ion having a larger ion radius than at least one of the alkali metal ions present in the optical glass.

Strengthening time, strengthening temperature and kind of used molten salt bath have to be selected considering the composition of the optical component to be strengthened and intended strengthening results.

Preferably, the strengthening temperature T1 of the molten alkali metal salt bath is the range of 350° C. to 500° C., preferably in the range of 370° C. to 450° C., particularly preferably in the range of 380° C. to 430° C. Further, preferably the strengthening time t1 is in the range of 0.5 to 24 hours, more preferably in the range of 1 to 15 hours and particularly preferably in the range of 2 to 8 hours.

In a particularly preferred embodiment of the method of the invention, step b) comprises immersing the optical component into a bath of molten alkali metal salt at a strengthening temperature T1 of 350 to 500° C. for a strengthening time t1 of 2 to 8 hours, wherein the molten alkali metal salt comprises at least KNO₃, preferably consists essentially of KNO₃.

The chemical strengthening is not limited to one single step. It can include multi steps in more than one salt bath with alkaline metal ions of various concentrations to reach better toughening performance. Thus, the chemically strengthened optical component according to the invention can be strengthened in one step or in the course of several steps, e.g. two steps.

In one preferred embodiment the method describe above further comprises the following steps:

b1) immersing the strengthened optical component obtained in step c) into a second bath of molten alkali metal salt at a certain strengthening temperature T2 for a certain strengthening time t2 to prepare a further strengthened optical component;
c1) lifting the further strengthened optical component out of the second alkali metal salt bath.

Preferably, the strengthening temperature T2 of the second molten alkali metal salt bath is the range of 350° C. to 500° C., preferably in the range of 370° C. to 450° C., particularly preferably in the range of 380° C. to 430° C. Further, preferably the strengthening time t2 is in the range of 0.5 to 24 hours, more preferably in the range of 1 to 15 hours and particularly preferably in the range of 2 to 8 hours.

The strengthening temperature T1 and T2 as well as the strengthening time t1 and t2 may be equal or different.

The molten alkali metal salt bath and the second alkali metal salt bath may comprise the same alkali metal ion(s). Further, the molten alkali metal salt bath and the second alkali metal salt bath may comprise different alkali metal salt(s). Preferably, the molten alkali metal salt bath comprises, preferably consists essentially of NaNO₃, or a mixture of NaNO₃ and KNO₃, and the second molten alkali metal salt bath comprises, consists essentially of, KNO₃ or a mixture of KNO₃ and NaNO₃ in a preferred weight ratio KNO₃:NaNO₃ of from 99:1 to 70:30, preferably 95:5 to 80:20, and particularly preferably from 92:8 and 88:12, and for example about 90:10.

In a preferred embodiment of the invention, the optical component is strengthened in one step.

The method according to the invention optionally may comprise after step d) the following step

e) touch polishing.

For the purpose of the invention “Touch polishing” means to slightly remove a thin layer of preferably less than 0.1 μm from at least a part of the surface of the chemically strengthened optical component. Although touch polishing reduces the DOL and also may decrease the CS of the polished surface, it enables removing optionally present surface defects generated during the ion-exchange. Therefore, the surface quality of the chemically strengthen optical component, can be improved and accordingly could be advantageous in regard of the mechanical strength of the chemically strengthened optical component.

After step e) as described above the method of the invention may comprise a further step f) final cleaning of the optical component obtained after step e).

In one embodiment the surface of the optical component is at least partly chemically strengthened, more preferably the complete surface of the optical component is chemically strengthened.

### Use of the Optical Components

The chemically strengthened optical component according to the invention is suitable for a multitude of applications, in particular under demanding conditions, which require optical components having defined optical properties in combination with improved mechanical strength.

Preferably the strengthened optical components are used in imaging sensors, microscopy, medical technology, digital protection, telecommunication, optical communications engineering/information transmission, optics/lighting in the automotive sector, photolithography, steppers, excimer lasers, wafers, computer chips and/or integrated circuits and electronic devices which contain such circuits and chips.

More preferably, the strengthened optical component is used in automotive cameras, smartphone cameras, cameras in consumer electronics devices, machine visual cameras, augmented reality and virtual reality camera or display modules, preferably waveguides for Augmented Reality devises, and sport cameras.

### EXAMPLES

The present invention is further illustrated by the following examples:

### A. Glass Compositions

The following table shows the compositions of the optical glass E1 to E5 of the present invention and of comparative example C1. The compositions are indicated in mol %. Thus, the relative molar proportions of the components of the glass are given with regard to the total composition.

TABLE 1
Compositions of optical glasses in mol %

| Component | E1 | E2 | E3 | C1 | E4 | E5 |
|---|---|---|---|---|---|---|
| SiO₂ | 40.38 | 35.59 | 36.38 | 36.84 | 1.00 | 2.94 |
| P₂O₅ | | | | | 20.22 | 26.24 |
| B₂O₃ | | | | 3.80 | 8.98 | 1.31 |
| Al₂O₃ | | 0.25 | | | | |
| Li₂O | | | | | | |
| Na₂O | 12.95 | 16.71 | 18.30 | 2.96 | 29.02 | 20.19 |
| K₂O | 4.82 | | | | 6.91 | |
| CaO | 1.25 | 1.22 | 1.56 | | 0.03 | 5.51 |
| MgO | | | | | | |
| SrO | | | | | | 0.09 |
| BaO | 7.80 | 8.93 | 7.40 | 16.24 | | 9.12 |
| ZnO | | | | 7.06 | | 3.80 |
| TiO₂ | 27.09 | 31.70 | 29.14 | 16.41 | 12.14 | 3.87 |
| ZrO | 0.14 | 1.25 | 1.34 | 5.67 | | |
| La₂O₃ | | | | 8.68 | | |
| Nb₂O₅ | 5.58 | 4.35 | 5.96 | 2.78 | 21.69 | 26.92 |
| Sb₂O₃ | 0.02 | | 0.05 | 0.02 | | |
| n_{d} | 1.805 | 1.87 | 1.847 | 1.850 | 1.808 | 1.859 |
| v_{d} | 25.4 | 23.8 | 23.8 | 32.2 | 22.8 | 22.7 |

### Example 1

### a) Chemical Strengthening of Optical Components

Samples of the optical glasses E1 to E5 according to the invention and comparative optical glass C1 having a size of 30×30×1 mm has been chemically strengthen by the following procedure:
1) Completely immerse the samples into a molten KNO₃ salt bath, keeping at 420° C. for 5 hours.
2) Cleaning the chemically strengthened samples [after cooling to room temperature] with deionized water.

### b). Test Methods

### 1. Ball Drop

A steel ball with the diameter of 20 mm and the mass of 32.65 g was used to impact the 30*30*1 mm chemically strengthened optical component at the center position. The glass sample was mounted on a 30*30 mm PMMA jig with a 1 mm wide inner stage to support the sample. The rest area of the jig was blank. The ball drop height started from 50 mm. After each impact, if the glass did not break, the ball drop height was increased for 25 mm and drop impact the sample again, until the sample was broken. The broken height was recorded and the failure impact energy could be calculated by the formula E=m×g×h, where m is the mass of the ball; g is the acceleration of gravity, and h is the breakage height. The B10 of the broken height and the failure energy could be calculated based on Weibull distribution.

### 2. Squeeze

The sample was mounted on the same jig as used in above described ball drop test. A spherical head with the diameter of 10 mm was used to press the center of the glass. The bending speed was 10 mm/min. The position was set as 0 point when the force reaches 0.1 N. The sample was bent until it breaks. The failure force was recorded and the B10 of the failure force could be calculated based on Weibull distribution.

### 3. Depth of Layer

SEM-EDS was used to scan the cross section of the ion-exchanged optical component. The DoL can be deduced from the ratio of K/Na following the depth to surface.

### 4. Refractive Index

The surface refractive index of the glass samples before and after chemical toughening were measured by Metricon Prism Coupler (Model 2010/M) based on critical angle of total reflection.

### 5. Hardness

Knoop Hardness expresses the amount of surface changes in a material after indentation of a test diamond at a given pressure and time. The standard ISO 9385 describes the measurement procedure for glasses. The test was performed on the polished surfaces of the chemically strengthened optical component at room temperature by a test force of 0.1 kgf and an effective test period of 20 s (HK 0.1/20).

### c) Results

The following tables summarizes the optical and mechanical properties of the original optical components E1 to E5 and C1 as well as the properties of the corresponding chemically strengthened optical components E1* to E5* and C1*.

TABLE 2
Optical and mechanical properties of optical components before and after chemically strengthening

| | E1 | E1* | E2 | E2* | E3 | E3* |
|---|---|---|---|---|---|---|
| Ball Drop (height, | 138 | 570 | 253 | 610 | 79 | 274 |
| mean, mm) | | | | | | |
| Ball Drop (Energy, | 43 | 179 | 79 | 191 | 25 | 86 |
| mean, J) | | | | | | |
| Ball Drop | | 414.7 | | 241.5 | | 344.7 |
| improvement (%) | | | | | | |
| Ball Drop (height, | 45.13 | 256.03 | 114.31 | 198.33 | 53.45 | 98.15 |
| B10) | | | | | | |
| Ball Drop (energy, | 14.15 | 80.29 | 35.85 | 62.20 | 16.76 | 30.78 |
| B10) | | | | | | |
| Ball Drop improved | | 567.3% | | 173.5 | | 183.6 |
| (B10) | | | | | | |
| Squeeze (mean, | 0.12 | 0.51 | 0.29 | 0.54 | 0.09 | 0.35 |
| load/KN) | | | | | | |
| Squeeze improved | | 439.2 | | 185.1 | | 400.6 |
| Squeeze (B10) | 0.04 | 0.30 | 0.17 | 0.32 | 0.05 | 0.18 |
| Squeeze improved | | 722.0 | | 188.6 | | 339.6 |
| (B10) | | | | | | |
| DoL (μm) | | 4.25 | | 1.510 | | 2.510 |
| Refractive index | 1.799 | 1.800 | 1.835 | 1.836 | 1.839 | 1.840 |
| Hardness HK | 530 | 568 | 521 | 545 | 533 | 536 |
| 0.1/20 | | | | | | |

TABLE 3
Optical and mechanical properties of optical components before and after chemically strengthening

| | E4 | E4* | E5 | E5* | C1 | C1* |
|---|---|---|---|---|---|---|
| Ball Drop (height, | 121 | 434 | 175 | 278 | 112 | 174 |
| mean, mm) | | | | | | |
| Ball Drop (Energy, | 38 | 136 | 55 | 87 | 35 | 55 |
| mean, J) | | | | | | |
| Ball Drop | | 359.7 | | 158.6 | | 156.0 |
| improvement (%) | | | | | | |
| Ball Drop (height, | 40.25 | 361.77 | 97.66 | 81.15 | 39.70 | 45.30 |
| B10) | | | | | | |
| Ball Drop (energy, | 12.62 | 113.45 | 30.63 | 25.46 | 12.45 | 14.21 |
| B10) | | | | | | |
| Ball Drop improved | | 898.8 | | 83.1 | | 114.1 |
| (B10) | | | | | | |
| Squeeze (mean, | 0.12 | 0.39 | 0.19 | 0.43 | 0.13 | 0.16 |
| load/KN) | | | | | | |
| Squeeze improved | | 338.3 | | 221.2 | | 124.1 |
| Squeeze (B10) | 0.07 | 0.36 | 0.12 | 0.22 | 0.06 | 0.05 |
| Squeeze improved | | 546.7 | | 175.3 | | 86.2 |
| (B10) | | | | | | |
| DoL (μm) | | 25.850 | | 1.250 | | 0.25 |
| Refractive index | 1.801 | 1.802 | 1.852 | 1.852 | 1.843 | 1.843 |
| Hardness HK | 410 | 440 | 449 | 467 | 593 | 585 |
| 0.1/20 | | | | | | |

It was found that the chemically strengthened optical components E1* to E5* of the invention have improved mechanical properties, in particular an improved hardness when compared to the corresponding non-strengthened optical components E1 to E5, even in cases where the DoL is comparatively small (E1). Moreover, it was found that the optical properties, i.e. the refractive index remain almost the same and does not vary more than 0.001.

### Example 2

### a) Chemical Strengthening of Optical Components

A polished wafer formed of optical Glass E6 with a thickness of 0.6 mm and double side high quality polished surfaces was provided.

The composition of E6 comprises the following components in mol %:

### SiO₂ 35-45

### Na₂O 8-18

### K₂O 1-10

### CaO<2

### BaO 5-10

### TiO₂ 25-35

### ZrO<1

Nb₂O₅ 2-8
Sb₂O₃<0.5

The samples for four-point bending test were prepared from the polished wafer by cutting CNC technology to cut the wafer by CNC technology into samples having a size of 60×20×0.6 mm. The samples were chemically strengthened by the following procedure:
1) Complete immersion of the samples into a molten KNO₃ salt bath, keeping at 430° C. for 6 hours.
2) Cleaning the samples after cooling to room temperature with deionized water.

### b) Test Methods

The four-point bending test was conducted according to DIN EN 1288-3. The sample was placed on two supporting pins with a set distance apart and two loading pins placed at an equal distance around the center. These two loadings were lowered from above at a constant rate until sample failure. In this test, the supporting span was 40 mm and the loading span was 20 mm. The lowing rate was 10 mm/min. The 4PB strength was calculated according to equation:

$$σ = {3}^{⋆} {F}^{⋆} ( L 1 - L 2 ) / ( {2}^{⋆} {W}^{⋆} t 2 )$$

wherein σ is the sample strength of flexural resistance; F is the breakage force; L1 is the span of the two supporting pins; L2 is the span of the two loading pins; W is the sample width; t is the sample thickness. The B10 of the 4PB strength could be calculated based on Weibull distribution.

### c) Results

TABLE 4
Optical and mechanical properties of optical components
before and after chemically strengthening

| | E6 | E6* | Improvement (%) |
|---|---|---|---|
| 4PB strength (MPa) average | 103 | 429 | 417 |
| 4PB strength (MPa) B10 | 96 | 367 | 383 |
| DoL (μm) | | 6.5 | |
| Refractive index | 1.796 | 1.797 | |
| Hardness HK 0.1/20 | 540 | 597 | 111 |

It was found that the chemically strengthened sample has a significantly increased mechanical strength compared to the not strengthened sample.

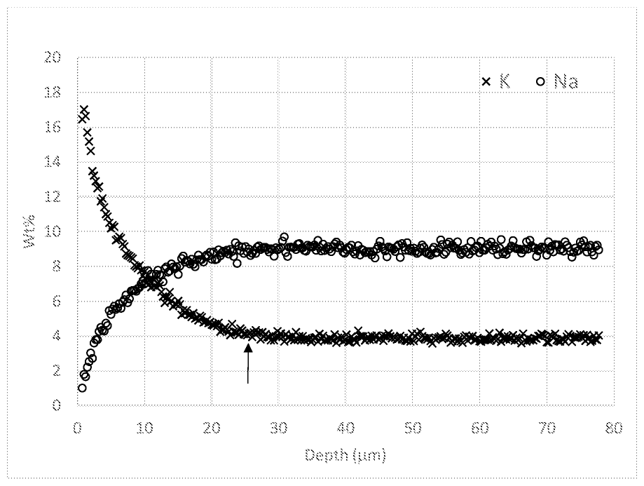

FIG. 1 illustrates the DOL in the chemically strengthened optical comptometer E6* after the ion-exchange process. The concentration of Na⁺ and K⁺ in wt % were measured according to FSM-EDS. The particular ion concentrations in a depth below 30 μm correspond to the concentrations in the optical component before the ion-exchange process. During the ion-exchange process Na⁺-ions near the surface of the optical component were exchanged by the K⁺-ions in the molten salt bath. Accordingly, as shown in FIG. 1 the K⁺-ion concertation near the surface of the optical component is significantly increased and the Na⁺-ion concertation was significantly decreased in comparison with deeper regions of the component. The decreasing curve fits the following function:

$$CC = AA 1 - erf \frac{xx}{2 \sqrt{DDDD}} ) ] + C {C}_{K K}$$

where A is a proportionality coefficient; erf is named “error function”, whose definition is

$$erf ( β ) = \frac{2}{\sqrt{π}} {{\int }_{0}}^{ββ} exp ( - {β}^{2} ) dd ββ$$

D is the K—Na ion-exchange coefficient in this process; C_{K} is the initial concentration of K⁺ in the raw glass.

Since equal molar Na ions were exchanged with K ions, the Na ions increase from surface to inner, correspondingly with the K ions' decreasing. Because the compressive stress in chemically toughened glasses is a result of the K—Na ion exchange, the depth of the (compressive stress) layer (DoL) can be recognized at where the K and Na ions are not affected by the ion-exchange, and therefore still keep their initial concentration in raw glass. In this case, it was found a DoL around 26 μm marked in FIG. 1 with an arrow.

1. A chemically strengthened optical component comprising an optical glass, having a Depth of Layer (DoL) of 1.0 to 50.0 μm, wherein the optical glass has a refractive index n_{d} of at least 1.65 and wherein the optical glass comprises at least 5 mol % of total of Li₂O, Na₂O and K₂O or a combination of two or more thereof.

2. The chemically strengthened optical component according to claim 1, wherein the optical glass has a composition in mol % comprising:

| Component | mol % |
|---|---|
| SiO₂ | 0-50 |
| Al₂O₃ | 0-2 |
| B₂O₃ | 0-15 |
| P₂O₅ | 0-35 |
| Li₂O | 0-15 |
| Na₂O | 0-35 |
| K₂O | 0-15 |
| Σ R₂O (R = Li, Na, K) | 5-45 |
| MgO | 0-10 |
| CaO | 0-10 |
| SrO | 0-10 |
| BaO | 0-15 |
| R′O (R′ = Mg, Ca, Sr, Ba) | 0-20 |
| ZnO | 0-10 |
| TiO₂ | 3-35 |
| Nb₂O₅ | 3-35 |
| Σ (TiO₂ + Nb₂O₅) | 20-55 |
| Ln₂O₃ (Ln = La, Y, Gd) | 0-10 |
| ZrO₂ | 0-5 |
| Σ (Sb₂O₃, As₂O₃, SnO₂, SO₃, Cl, | 0-0.5 |
| F) | |

3. The chemically strengthened optical component according to claim 1, wherein the optical glass has a composition in mol % comprising:

| Component | mol % |
|---|---|
| SiO₂ | 25-50 |
| Al₂O₃ | 0-2 |
| B₂O₃ | 0-10 |
| P₂O₅ | 0-5 |
| Li₂O | 0-15 |
| Na₂O | 0-30 |
| K₂O | 0-10 |
| Σ R₂O (R = Li, Na, K) | 5-25 |
| MgO | 0-5 |
| CaO | 0-5 |
| SrO | 0-3 |
| BaO | 0-15 |
| Σ R′O (R′ = Mg, Ca, Sr, Ba) | 5-15 |
| ZnO | 0-5 |
| TiO₂ | 20-35 |
| Nb₂O₅ | 1-15 |
| Σ (TiO₂ + Nb₂O₅) | 22-45 |
| Ln₂O₃ (Ln = La, Y, Gd) | 0-5 |
| ZrO₂ | 0-5 |
| Σ (Sb₂O₃,SnO₂, As₂O₃, SO₃, Cl, | 0-0.5 |
| F) | |

4. The chemically strengthened optical component according to claim 2, wherein the optical glass has a composition in mol % comprising:

| Component | mol % |
|---|---|
| SiO₂ | 0-5 |
| Al₂O₃ | 0-2 |
| B₂O₃ | 0-15 |
| P₂O₅ | 15-35 |
| Li₂O | 0-15 |
| Na₂O | 5-35 |
| K₂O | 0-10 |
| Σ R₂O (R = Li, Na, K) | 10-45 |
| MgO | 0-5 |
| CaO | 0-10 |
| SrO | 0-5 |
| BaO | 0-15 |
| Σ R′O (R′ = Mg, Ca, Sr, Ba) | 0-15 |
| ZnO | 0-5 |
| TiO₂ | 3-35 |
| Nb₂O₅ | 10-35 |
| Σ (TiO₂ + Nb₂O₅) | 20-55 |
| Ln₂O₃ (Ln = La, Y, Gd) | 0-10 |
| ZrO₂ | 0-5 |
| Σ (Sb₂O₃, As₂O₃, SnO₂, SO₃, Cl, | 0-0.5 |
| F) | |

5. The chemically strengthened optical component according to claim 1, wherein the optical glass comprises at least 8 mol % Na₂O and optionally at least one of Li₂O and K₂O.

6. The chemically strengthened optical component according to claim 1, wherein the optical glass comprises at least 10 mol % Na₂O, at least 3 mol % K₂O and optionally Li₂O.

7. The chemically strengthened optical component according to claim 1, wherein the optical glass comprises at least 15 mol % Na₂O, at least 5 mol % K₂O and optionally Li₂O.

8. The chemically strengthened optical component according to claim 1, wherein the optical glass comprises Na₂O, K₂O and optionally Li₂O, wherein the molar ratio of Na₂O to K₂O (Na₂O/K₂O) is more than 1.0 and less than 5.0.

9. Method for preparing the chemically strengthened optical component, comprising the following steps:
a) providing an optical component comprising an optical glass as described in claim 1;
b) immersing the optical component into a bath of molten alkali metal salt at a certain strengthening temperature T1 for a certain strengthening time t1 to prepare a strengthened optical component;
c) lifting the strengthened optical component out of the molten alkali metal salt; and
d) cooling and optionally cleaning the strengthened optical component.

10. Method according to claim 9, wherein the strengthening temperature T1 is 350 to 500° C. and the strengthening time t1 is 2 to 8 hours.

11. Method according to claim 9, wherein the molten salt bath consists essentially of KNOB.

12. Method according to claim 9, comprising the further steps
b1) immersing the strengthened optical component obtained in step c) into a second bath of molten alkali metal salt at a certain strengthening temperature T2 for a certain strengthening time t2 to prepare a further strengthened optical component;
c1) lifting the further strengthened optical component out of the second alkali metal salt bath.

13. An image sensor, a microscopy device, a medical technology device, a digital protection device, a telecommunication device, an optical communications engineering/information transmission device, an automotive optics/lighting device, a photolithography device, a stepper, an excimer laser, a wafer, a computer chip and/or an integrated circuit, an electronic device which contain such circuit and chip, an automotive camera, a smartphone camera, a camera in a consumer electronics device, a machine visual camera, an augmented reality and virtual reality camera, a display module or a sport camera comprising the chemically strengthened optical component according to claim 1.
